(19) United States
(12) Patent Application Publication
(10) Pub. No.: US 2017/0013102 A1
(43) Pub. Date: Jan. 12, 2017

(54) MULTI ENDED TELECOM TEST ADAPTER

(71) Applicant: Westek Electronics, Inc., Watsonville, CA (US)

(72) Inventor: Kevin B. LARKIN, Pebble Beach, CA (US)

(73) Assignee: Westek Electronics, Inc., Watsonville, CA (US)

(21) Appl. No.: 15/205,976

(22) Filed: Jul. 8, 2016

Related U.S. Application Data
(60) Provisional application No. 62/190,684, filed on Jul. 9, 2015.

(51) Int. Cl. H04M 1/24; H01R 24/64; H01R 31/06

(52) U.S. Cl. CPC H04M 1/24; H01R 31/065; H01R 24/64; H01R 2107/00

(57) ABSTRACT

The use of a single entry multi-pair connector is described. The single entry multi-pair connector allows all the pairs of 2, 4, 6, or 8 to be individually connected to their own individual contact points.

This invention allows the multi ended Telecom and data test cords to operate at the highest level of transmissions provided over the copper pair.

If you have a test cord that has three to four plug ends on it, they are generally connected inside a Y junction, since the telephone system was developed using up to two copper pairs, and only one copper pair was used to monitor the pair at a time.

The test set known as the butt set or handheld test was originally designed to access or bridge into one pair at a time. The amount of leads coming from that buttset was/is two. This has always been the means of bridging onto the telephone line.

With the invention of the multi ended test cords, the only way to connect to this single pair test set was to combine the additional test end pair internally in a Y junction combining four pairs to one pair, four tip wire to one tip from the test set and four ring wires connected to one single ring wire coming from the test set. These additional, unused pairs, left hanging in the air, and act as mini antennas- causing a condition referred to as “bridge taps”.

Generally, reducing the cost in all industries is a common goal; in regards to that the concept of this invention is to not only isolate the pair, but also reduce the cost by not having an electrical switch.

The Isolated Pairs are packaged with two test ends. The technician has everything they need at their fingertips for testing, saving time and money.

### FIGURES

FIG. 1: Cable Assembly, is a depiction of a Combination cable where 8 positions on the Modular Plug break out within the Y-Mold to 4 separate pairs within the Telco Panel connectors.

FIG. 2: Banjo Modular test adapter is a depiction of the adaptor labeled with Pair 1, Pair 2, Pair 3, and Pair 4, which correspond with the Pairs on the FIG. 1 Cable assembly.

FIG. 3: Test Equipment, is a depiction of a test apparatus with clips that attach to contact tabs on the FIG. 2 test adapter.

FIG. 4: Wring diagram for Test adapter: is a depiction of the internal wiring of the FIG. 2 modular test adapter which shows the 8 position modular jack breaking out to the 4 contact tab pairs.

FIG. 5: Wring Diagram for Cable assembly, is a depiction of the internal wiring of FIG. 1 Cable assembly where the 8 position modular plug breaks out into the 4 Telco connector pairs.

FIG. 6: is a depiction of the FIG. 2 test adapter and FIG. 1 cable assembly in the disconnected position.

FIG. 7: is a depiction of FIG. 3 Test equipment clipped on the contact tabs of FIG. 2 Test Adaptor, which is connected via the 8 position modular Plug/Jack to FIG. 1 cable assembly.

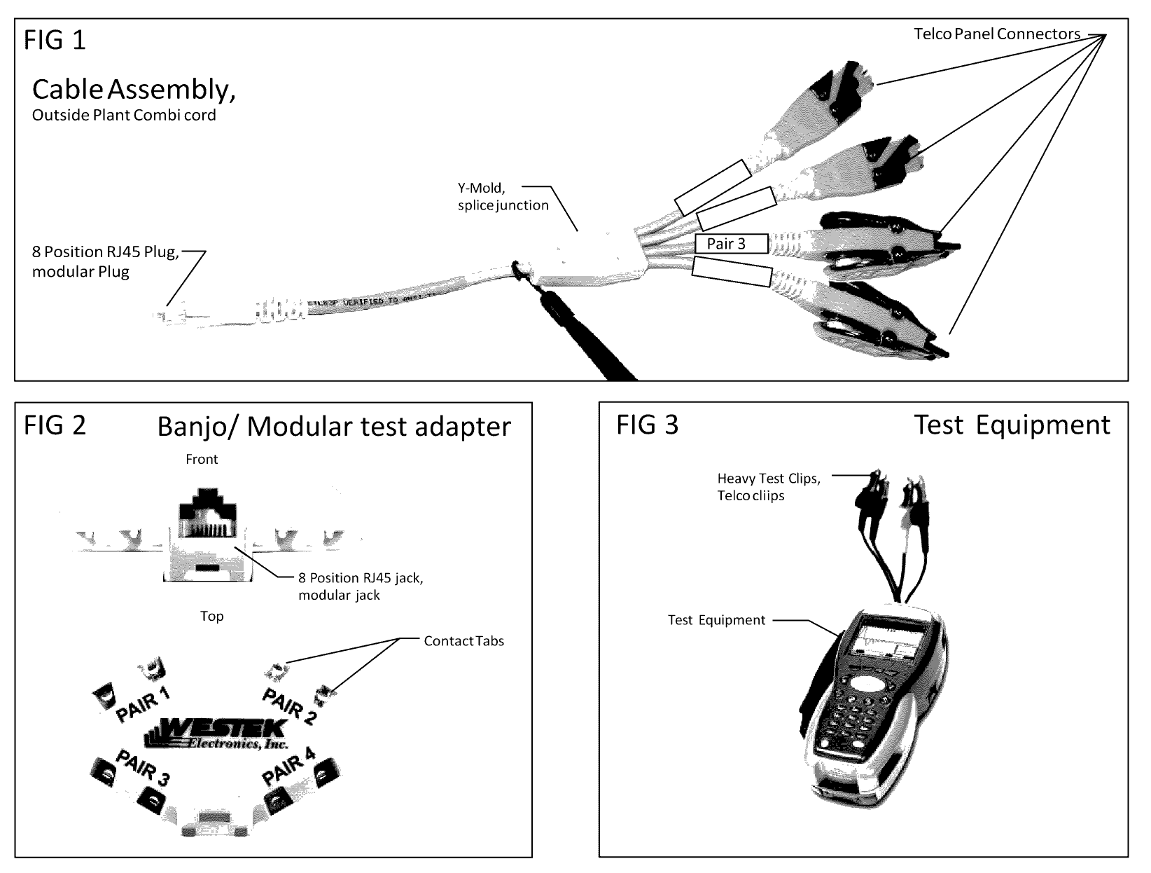

1) The use of a single entry multi-pair connector that allows all the pairs of 2, 4, 6, or 8 to be individually connected to their own individual contact points. Reference FIG. 1 and FIG. 5.

2) The opposite end of the individual contact pair points/pads would be completely isolated and insulated until it made contact with the specialized contact points in the specified plug-in.

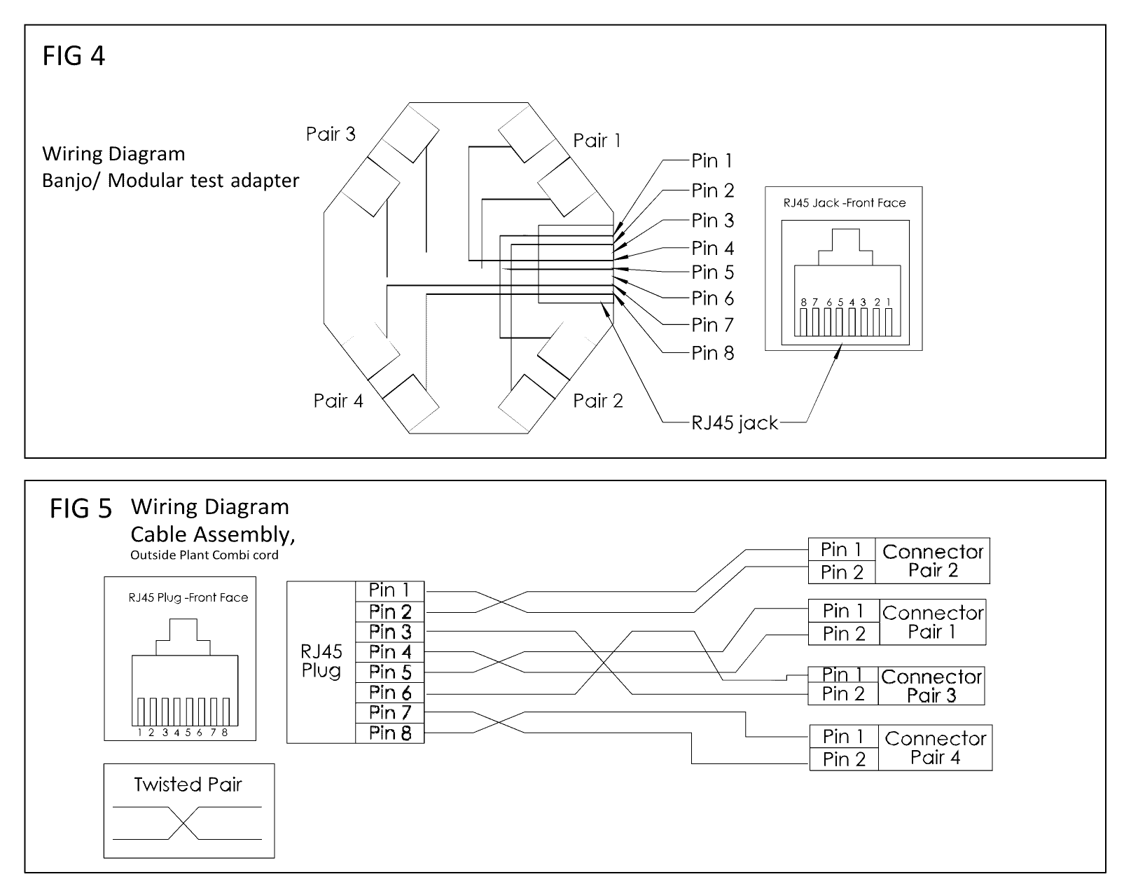

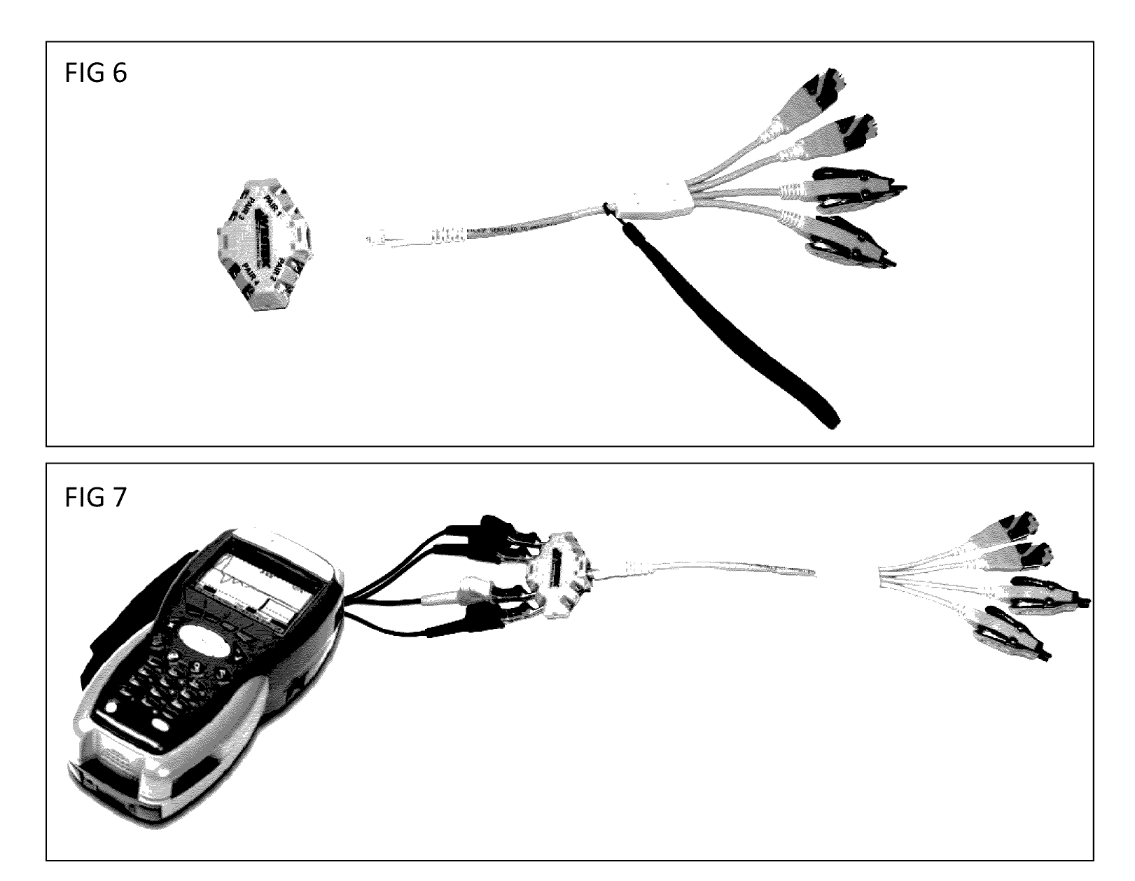

3) The housing that connects to the test set end can be in the form of a modular jack. Today modular jacks are not functioned to facilitate test sets without means of a multi ended contact point because test sets are not designed to switch to access all four pairs independently; when that day arrives, this patent will still be valid because it is just transferring the size and mean of contact points to the individual isolated contact pair. Reference FIG. 2 and FIG. 4.

4) With the means of the contact to the four paired contact point housing through a modular connection; the contact pair housing can be turned into an additional tool that can test back into the network as is common today. Once the cable assembly is placed onto the modular connection, an exclusive means of identifying each specific pair/contact tab to test each Leg 1, Leg 2, Leg 3 Leg 4 so the technician will easily identify which Tab to connect to each Leg. Reference FIG. 1, FIG. 2, FIG. 4, and FIG. 5.
